(19) United States
(12) Patent Application Publication
(10) Pub. No.: US 2018/0268467 A1
(43) Pub. Date: Sep. 20, 2018

(54) NAVIGABLE GRAPH OF CONNECTIONS BETWEEN SERVICES

(71) Applicant: Amazon Technologies, Inc., Seattle, WA (US)

(72) Inventors: Thibaut Labarre, Seattle, WA (US); Sheng Bi, Bellevue, WA (US); Nicholaus Alexander Malone, Seattle, WA (US); Shwu Fang Loh, Seattle, WA (US); Vikas Seshagiri Rao Bhardwaj, Seattle, WA (US)

(21) Appl. No.: 14/703,694

(22) Filed: May 4, 2015

(51) Int. Cl. G06Q 30/06; G06F 17/30

(52) U.S. Cl. CPC G06Q 30/0641; G06F 17/30961

(57) ABSTRACT

Techniques are provided for presenting and dynamically updating a user interface that represents features/services associated with a service provider. For example, a user interface element associated with services offered by a service provider may be maintained. Further, instructions to present the user interface element with at least a first portion that represents a service of the services that is accessible may be provided. Information corresponding to an interaction with the service provider may be received. A second portion of the user interface element to present may be determined based at least in part on the received information and aggregate user data that identifies interactions by a plurality of users with the services offered by the service provider. Instructions may be provided to present the user interface element with the first portion and the determined second portion.

### BACKGROUND

Current network technologies provide a number of beneficial services to users of the Internet and other networks. For example, users are able to search, view, and purchase a number of products from electronic marketplaces, communicate with other users on the other side of the world, consume electronic content including music and video content, or play games with other users via the Internet. However, varied implementations of electronic marketplaces or other online service providers may also create several problems for users, such as confusing site layouts that fail to properly inform the users of all available features. Users may feel lost while trying to explore a number of services offered by a service provider or feel like they haven't received enough information to properly utilize the services. While some of the services/features provided may be appropriate or useful to the user, the sheer amount of additional services/features may result in the user being disengaged and missing opportunities to utilize services that they would otherwise find useful or helpful.

### BRIEF DESCRIPTION OF THE DRAWINGS

Various embodiments in accordance with the present disclosure will be described with reference to the drawings, in which:

FIG. 1 illustrates an example of a service provider interface associated with services offered by a service provider, according to embodiments;

FIG. 2 illustrates an example of a service provider interface associated with services offered by a service provider, according to embodiments;

FIG. 3 illustrates an example flow for generating and updating an initial service provider interface associated with services offered by a service provider, according to embodiments;

FIG. 4 illustrates several examples of a portion of a service provider interface associated with services offered by a service provider, according to embodiments;

FIG. 5 illustrates an example service provider interface associated with services offered by a service provider, according to embodiments;

FIG. 6 illustrates an example service provider interface module, according to embodiments;

FIG. 7 illustrates an example flow diagram for a service provider interface associated with services offered by a service provider, according to embodiments;

FIG. 8 illustrates an example flow diagram for a service provider interface associated with services offered by a service provider, according to embodiments;

FIG. 9 illustrates an example computer architecture for implementing a service provider interface associated with services offered by a service provider, according to embodiments; and

FIG. 10 illustrates an environment in which various embodiments can be implemented.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments herein are directed to dynamically updating and presenting a service provider interface (e.g., a connection interface) that represents features/services associated with a service provider. Specifically, systems and methods are provided for utilizing aggregate data representing interactions by a plurality of users with services offered by a service provider, such as an electronic marketplace, to generate and update a user interface that represents services offered by the service provider and the interrelationships between and among the services. Further, information that indicates that a user has interacted or taken an action with a particular service (that corresponds to an element in the user interface) can be utilized to dynamically update the structure or layout of the user interface, and therefore the presentation of the user interface provided to the user.

The information may include the behavior pattern of the user with services/features provided by the service provider or the usage pattern of services/features provided by the service provider and utilized by the user. In embodiments, an algorithm may utilize the aggregate data and the information about the interaction by the user with a service to determine portions of the user interface to update and present to the user. The user interface may be updated in such a way as to preview and guide the user to services which are complimentary to services already explored or being explored by the user. The updated user interface may visually indicate services that were previously inaccessible (e.g., not visible) or unknown to the user, via the user interface, prior to the update. It should be noted that while the updated user interface may visually indicate services that were previously inaccessible via the user interface, the services themselves may be currently implemented or offered by the service provider. In other words, they may be inaccessible to this particular user, but not necessarily to others. Thus, the updated user interface provides a way for service providers to guide and inform a user of potentially useful services that are currently unutilized by the user without inundating the user with information that may cause confusion or frustration.

In a non-limiting example, an initial tree graph, that may be generated by a service, may be presented to a user in a network document (e.g., web page) provided by a service provider. The tree graph may have one or more nodes that each represent a service currently offered by the service provider. Placement of the nodes and paths to and from each node may indicate the relationships between the services of the service provider. Further, the tree graph may implement several types of indicators to aid in guiding the user in exploring the nodes (services provided by the service provider) of the tree graph. For example, the initial tree graph may have a portion of nodes that are blank or “greyed out” to represent that the user has not explored a particular amount of related nodes to indicate what services are represented thereby. A blank node or portion of a user interface may represent a feature that is known and offered by the service provider but is unknown or not utilized by the user interacting with the initial tree graph. A “greyed out” node may represent a feature that is graphically represented in a node included in the tree graph but that is inaccessible or is incapable of having its status updated until the user has taken certain actions with the corresponded service that is associated with the “greyed out” node. A different portion of nodes may utilize an icon representative of the corresponding service that is highlighted to indicate that the user has explored the service while a greyed out icon may represent that the user has been recommended the additional service but has yet to complete the requisite interaction in order to have properly explored the service (e.g., to change from greyed out to highlighted). Other nodes that are adjacent to explored or unexplored nodes may utilize lock symbols to indicate that the user may need to complete certain interactions with certain services before further progress can be made in the tree graph. In embodiments, the service may receive information that indicates that the user has performed an action with a service corresponding to an unexplored or greyed out node. Based on the information and aggregate data that represents interactions by a plurality of users with services offered by the service provider, the service may determine which services should be correlated with the nodes adjacent to the recently explored nodes and therefore which portion of the initial tree graph to update and present to the user. Thus, a path may be generated through the tree graph that may be individualized to the user and that represents the user exploring services that are potentially beneficial to the user.

In accordance with at least one embodiment, an initial user interface that represents services and the relationships between the services offered by the service provider may be generated utilizing aggregate data. In embodiments, as more aggregate data is obtained or as the aggregate data is updated over time, the initial user interface may also be updated for subsequent users of the service provider interface (e.g., a dynamic user interface) associated with services provided by a service provider. An administrator or other user associated with the service provider may provide overrides for inserting new nodes or elements in the initial user interface that are representative of newly added services. However, the system implementing embodiments described herein may utilize the aggregate data and interactions by a user to move the placement of the node to a more appropriate position in the user interface. In embodiments, the portion of the user interface that is dynamically updated to present services that were previously inaccessible (features/services on the horizon) may be determined based on the usage pattern of services utilized by a particular user and the aggregate data.

It should be noted that the aggregate data may include aggregate data of every interaction by the plurality of users with any services offered by a service provider or a segment of interactions by the plurality of users with services that are related to the service that is currently being viewed or explored by the user. Each time a user interacts with a service, according to prerequisites associated with the service, information may be received about the interaction that represents an event that triggers calculation of a new horizon for updating the portion of the user interface. Updating the portion of the user interface may result in revealing new services that are related to the recently explored service for presentation to the user via the updated user interface. Thus, each user may be presented with their own service provider interface that reflects their respective actions with regard to services offered by a service provider. The system implementing embodiments described herein may generate the horizons or portions of the user interface to present to the user in such a way as to guide the user to related services that the user may potentially find useful and to aid the user in being more proficient or specialized in a service category offered by the service provider. For example, a service provider may offer various shipping methods yet a user is only aware or has only utilized one of the many shipping methods offered. Embodiments described herein may be utilized to update a user interface that will aid the user in learning and understanding the different shipping methods offered by the service provider through dynamically updating the user interface to include explored services and unexplored related services that are on the horizon (along with instructions to update the user interface for the service from unexplored to explored).

In a non-limiting example, a tree graph with one or more nodes may be presented to a user upon the user viewing a web page provided by a service provider. The one or more nodes may each represent a service offered by the service provider and the paths between the nodes may denote the relationships between the services. A parent node may represent the user and several children node below the parent node may represent specific services that the user has previously interacted with. For example, one child node may include a premium level service that branches out to two more subsequent children node that each have different graphical representations of services offered by the service provider as well as status indicators indicating that the user has not explored or interacted with the services. The user may interact, via a mouse pointer, with one of the children node to be provided with instructions on how to progress down particular paths of the tree graph and explore more nodes. Upon the user following the instructions and interacting with a service, the tree graph may update the graphical representations of the services and nodes included in the tree graph to reveal or make accessible more services that are related to the recently explored services. For example, the user may have uploaded a media file to a media file storage service in response to receiving instructions from the media storage node in the tree graph. A computer system implementing the service provider interface may update the tree graph to change the status indicator for the media storage node to explored and reveal or make accessible one or more additional services that are related to the media storage node such as a streaming media service.

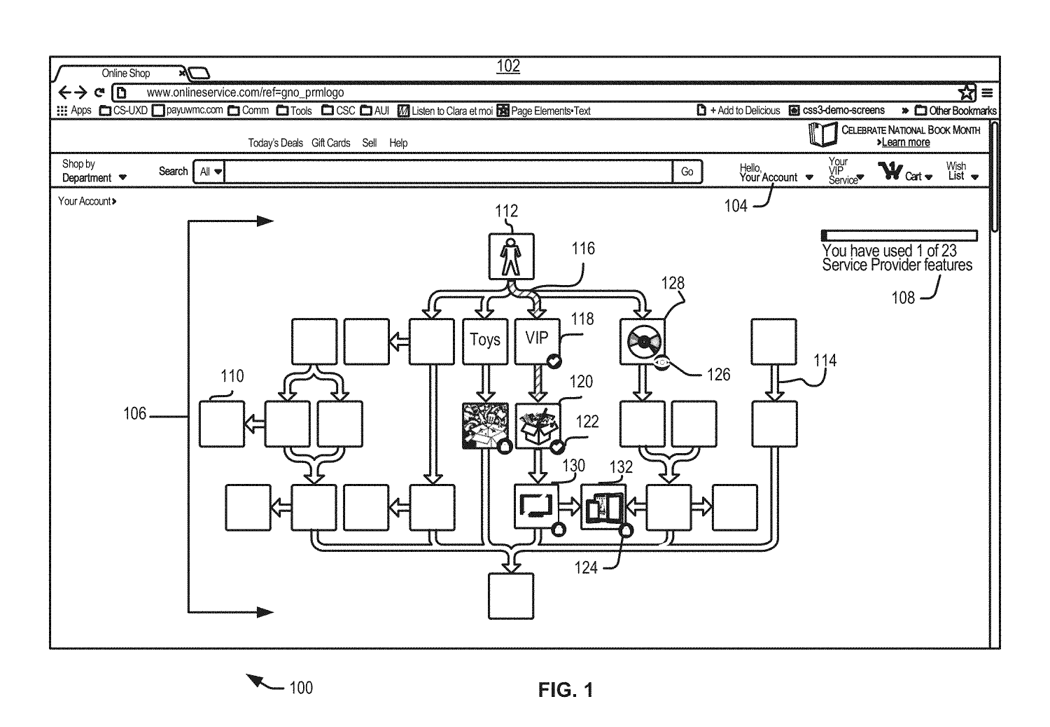

FIG. 1 illustrates an example of a service provider interface associated with services offered by a service provider, according to embodiments. The user interface 100 of FIG. 1 is presented via a web page browser 102. The web page browser 102 includes information indicating an account 104 for a user as well as a tree graph 106 presented in the web page browser 102 that represents features/services offered by a service provider, such as an electronic marketplace. The web page browser 102 may also provide an indication 108 of services currently being utilized by the user. The indication 108 of currently utilized services may update based on the usage pattern of the user with services provided by the service provider and may reflect changes to the tree graph 106. The tree graph 106 includes one or more nodes 110 that each represent a service/feature provided by the service provider. The tree graph 106 may also include a parent node 112 that represents the user themselves to indicate that each tree graph is individualized for each particular user, as described herein.

The tree graph 106 may include one or more paths 114 that indicate the relationships between nodes (services) of the tree graph and an explored path 116 of the user. The explored path 116 aids the user in visualizing the path through the nodes (services) that the user has previously explored or is currently exploring as well as nodes (services) that have yet to be explored or interacted with. For example, the explored path 116 of the tree graph 106 illustrated in FIG. 1 indicates that the user 112 has explored or interacted with services represented by nodes 118 and 120. In embodiments, the tree graph 106 or any suitable user interface may utilize various indicators to denote various statuses related to nodes (services) included in the tree graph 106. For example, the tree graph 106 of FIG. 1 includes an explored or interacted indicator 122, an unexplored indicator 124, and a preview indicator 126. The explored indicator 122 for node 120 indicates that the user has successfully explored or interacted with the service represented by the node of the tree graph 106. As can be seen in FIG. 1 the explored indicators, such as 122, appear on the explored path 116.

As described herein, the tree graph 106 (or the suitable user interface utilized in embodiments) can be updated to reveal (make accessible) nodes, such as node 128, for exploration and interaction. A system implementing the service provider interface associated with services offered by a service provider may utilize the usage patterns or behavior patterns of the user 112 with the services offered by the service provider and the aggregate data of a plurality of users interacting with the same services to determine the portion of the tree graph 106 to update and reveal to the user. For example, the updated node 128 may represent a media storage service that is related to a very important person (VIP) service (node 118) that was recently interacted with by the user 112. The system implementing features described herein may determine that the tree graph 106 should be updated or changed to reveal (make accessible) node 128 for exploration or interaction by the user. In embodiments, the user may interact with node 128 on the tree graph 106 to be provided with instructions or information indicating prerequisites or interaction steps to take in order to explore or unlock the node and the associated service in the tree graph 106. For example, the information may indicate that the user needs to upload a media file to a server associated with the service provider of node 128 in order to be awarded an explored status of node 128.

In some embodiments, an algorithm may be utilized to determine nodes that may be previewed or included in the updated portion of tree graph 106. The algorithm may utilize the usage patterns of a particular user, such as user 112, and aggregate data from a plurality of users interacting with the services provided by the service provider to determine the nodes (services) to be revealed or made accessible via the updated portion of the tree graph 106. For example, the tree graph 106 of FIG. 1, the tree graph 106 may have been updated to reveal node 128, as described above, and nodes 130 and 132. Nodes 130 and 132 may also include a lock indicator 124 that indicates that the nodes are on the horizon or soon to be revealed to the user upon their interaction with services represented by other nodes in the tree graph 106. In embodiments, the user may interact with nodes 130 and 132 to be provided with information that indicates how to unlock or make available the nodes 130 and 132 in the tree graph 106. It should be noted that node 110, a blank node, represents areas of the tree graph that have yet to be explored by the user thus driving the user via curiosity to explore or interact with various services offered by the service provider.

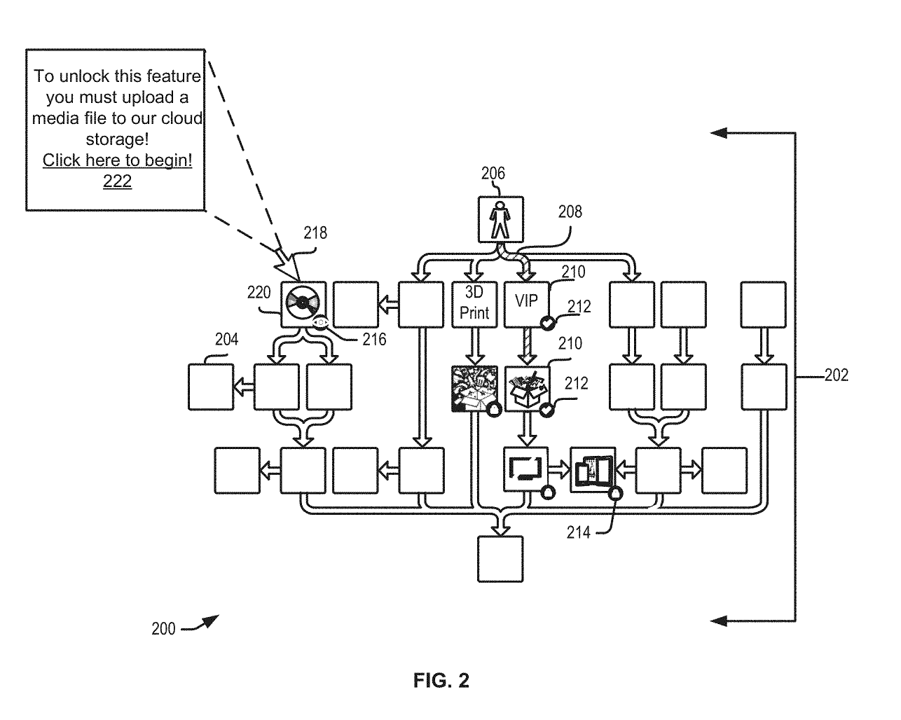

FIG. 2 illustrates an example of a service provider interface associated with services offered by a service provider, according to embodiments. The user interface 200 of FIG. 2 includes a tree graph 202 (similar to tree graph 106 from FIG. 1) that includes one or more nodes 204, the nodes 204 representing services/features offered by a service provider such as an electronic marketplace. It should be noted that although FIG. 2 includes a tree graph 202 that represents various services/features offered by a service provider, other user interfaces may be utilized to illustrate or visualize the services/features provided by a service provider that incorporate the features of the current disclosure. For example, a bar graph, an a-cyclical graph, cyclical graph, directed graph, a site map, or a series of web pages may be utilized to represent features/services provided by a service provider that can be updated according to embodiments described herein. The tree graph 202 may include a parent node 206 that represents a particular user, an explored path 208 that includes one or more explored nodes 210. The explored nodes 210 may represent features/service offered by the service provider that the user has previously or is currently interacting with or exploring via the service provider. The explored/interacted status may be represented by a check mark indicator 212.

As described above in FIG. 1, the tree graph 202 may also utilize other indicators such as a lock indicator 214 for nodes that are not accessible but visible to the user and an eye symbol 216 for nodes that the user can interact with and successfully explore (upon interacting with the service represented by the node associated with the eye symbol 216). The user interface 200 of FIG. 2 includes a user input indicator 218, such as a mouse pointer or any other suitable user input indicator, scrolling over node 220. Node 220 may represent a service that has been newly revealed to the user via the tree graph 202 being updated according to embodiments described herein. In embodiments, upon the user interacting, via the user input indicator 218, with node 220, the user may be presented with information 222 indicating instructions on how to interact with the service associated with node 220 to adequately explore the service and update the tree graph 202. The presented information 222 may include one or more steps or actions that the user must take with the service represented by node 220 in order to be awarded an unlock symbol over the node and to progress in the tree graph or other user interface in exploring the services/features represented by tree graph 202.

In embodiments, the information 222 may include one or more hyperlinks that direct or enable the user to interact with the appropriate service for carrying out the required actions for the service. For example, the information 222 includes instructions to upload a media file to a cloud storage associated with the service provider and a hyperlink (illustrated by the underlined text) to the appropriate service. It should be noted that although FIG. 2 utilizes a specific example of an action to be taken by the user to adequately explore a service offered by a service provider, the actions or instructions provided to the user for interacting with services offered by a service provider may vary and change based on the service represented by the node. For example, a shipping feature/service offered by a service provider may require that the user actually send a package via the particular shipping feature to get credit for interacting with the service.

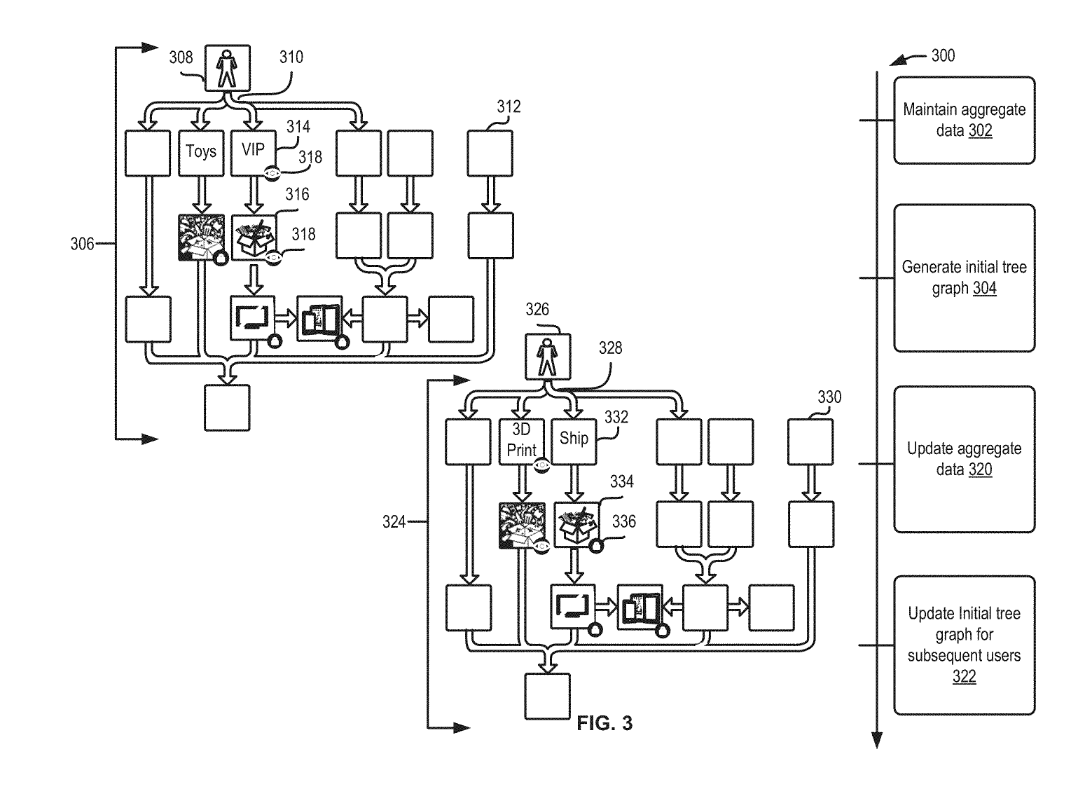

FIG. 3 illustrates an example flow for generating and updating an initial service provider interface associated with services offered by a service provider, according to embodiments. The example flow 300 illustrated in FIG. 3 includes one or more operations. However, the order in which the operations are described is not intended to be construed as a limitation, and any number of the described operations can be combined in any order and/or in parallel to implement the described flow. The flow 300 may include maintaining aggregate data at 302. In embodiments, a system implementing embodiments described herein may capture or obtain interactions from a plurality of users with services/features provided by a service provider, such as an electronic marketplace. The aggregate data may include the interactions of the plurality of users with the services/features including the order and time with which the users interacted with one service/feature to another service/feature. The flow 300 may include generating an initial tree graph at 304. For example, FIG. 3 includes an initial tree graph 306 that includes a parent node 308 that represents a particular user, one or more paths 310 that represent the relationships and associations between features/services offered by the service provider, and nodes 312 that represent the features/services offered by the service provider.

Particular nodes, such as nodes 314 and 316 may each represent a different service offered by the service provider and may be associated with indicators 318 that indicate the status of the nodes as described herein (explored/interacted with, preview, locked, blank). For example, node 314 may represent a VIP service, that a user may purchase membership to, and that encompasses a suite of associated services offered by the service provider. Node 316 may represent a random item service that offers deals on random items throughout the day. The initial tree graph 306 may include one or more blank nodes that represent features that have not been made accessible or revealed to the user. The flow 300 may include updating the aggregate data at 320. For example, the system implementing embodiments described herein may capture or obtain updated interactions from a plurality of users with services/features provided by the service provider. The aggregate data may include the interactions of the plurality of users with the services/features including the order and time with which the users interacted with one service/feature to another service/feature at a subsequent time point from when the aggregate data was captured/obtained for generation of the initial tree graph 306. The flow 300 may conclude by updating the initial tree graph for subsequent users at 322. For example, FIG. 3 illustrates an updated initial tree graph 324 that also includes a parent node 326 representing a user, one or more paths 328 that represent the relationships and associations between features/services offered by the service provider, and nodes 330 that represent the features/services offered by the service provider.

Particular nodes, such as nodes 332 and 334 may each represent a different service offered by the service provider and may be associated with various indicators 336 that indicate the status of the nodes as described above. The updated initial tree graph 324 has been updated to include different services represented by different nodes, such as node 332. For example, one of the initial nodes (332) of the updated initial tree graph 324 has been updated to represent a shipping service rather than the VIP service (node 314 of tree graph 306). In embodiments, the system implementing the embodiments described herein may update the nodes and the relationships between the nodes to generate a tree graph (such as graph 324) that is different from another initial tree graph (tree graph 306) based on the updated aggregate data (320).

In some embodiments, an administrator or developer associated with the service provider may generate the initial tree graph (such as initial tree graph 306) to provide to users of a service that includes embodiments described herein. The administrator or developer may define the locations and relationships between the nodes and therefore the services offered by the service provider. In embodiments, the initial tree graph may be changed based on an algorithm that utilizes the updated aggregate data 320. For example, a supervised machine learning algorithm may utilize the updated aggregate data to change, move, or update the initial tree graph to change the placement of nodes in the tree graph and to change the associations between nodes. For example, the updated initial tree graph 324 includes a node 332 representing a shipping service where the previous initial tree graph 306 included a VIP service node 314 in the same position of the tree graph. It should be noted that the updated initial tree graph 324 may include several blank nodes, such as 320, that may also represent updated service representations as a result of the algorithm utilizing the updated aggregate data. FIG. 3 illustrates the importance of utilizing aggregate data and personalized usage patterns of a user to update the associations and relationships of services by highlighting the different paths that can be utilized to reach a similar service. For example, the initial tree graph 306 includes a toy service and the VIP service (node 313) leading to the random item service 316 whereas updated initial tree graph 324 illustrates a different path leading to the same service (334) via the shipping service (node 332). Embodiments described herein include the capability to determine various paths of services that lead to a similar service. The path information can be utilized to restructure or re-associate the relationships between services. For example, the updated aggregate data 320 may indicate that the random item service (node 334) should be associated with the shipping service 302 rather than the VIP service 314.

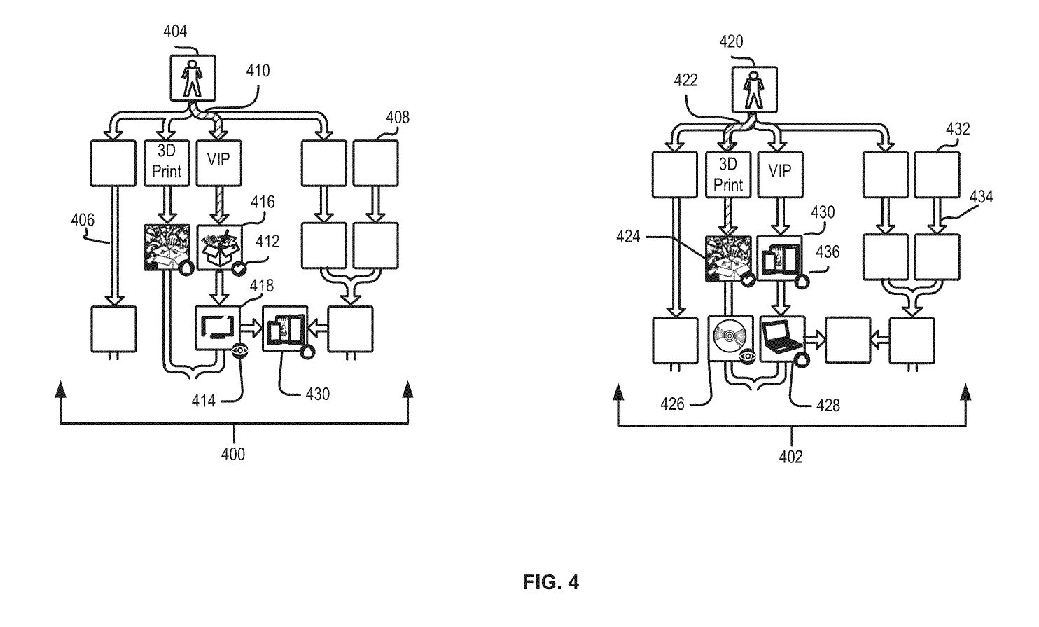

FIG. 4 illustrates several examples of a portion of a service provider interface associated with services offered by a service provider, according to embodiments. FIG. 4 includes two portions (400 and 402) of a service provider interface associated with services offered by a service provider. The two portions (400 and 402) each represent a portion of a tree graph (such as tree graph 106 from FIG. 1) that have each been updated based on the maintained aggregate data and the usage patterns or behavior pattern of a particular user to reveal or make accessible different nodes and therefore different associated services. For example, portion 400 of the user interface may include a parent node 404 representative of a particular user, one or more paths 406 that represent the relationships and associations between features/services offered by the service provider, and one or more nodes 408 that each represent features/services offered by the service provider. The portion 400 of the user interface may include an explored path 410 that represents the path of services explored or interacted with by the particular user 404. The portion 400 may include several indicators that represent the status of nodes within the portion of the user interface such as indicators 412 and 414 (explored and preview respectively). In FIG. 4, the portion 400 of the user interface includes a particular node 416 explored by the user or whose associated service has been interacted with by the user 404, as well as a preview node 418 that has been revealed or made accessible based on the usage pattern of the user (interacting with the VIP node and the particular node 416) and aggregate data representative of other users who have made similar choices in the user interface.

In comparison, the updated portion 402 of the user interface for another user, represented in node 420, has been updated to reveal or make accessible different nodes (and thereby different services offered by the service provider) based on the usage pattern of the user (node 420) and the aggregate data (which may or may not include the same aggregate data utilized for updating portion 400). For example, the updated portion 402 includes a different explored path 422 that results in exploration of or interaction with a 3D print service and an online selling service (represented by node 424). As a result of an algorithm, such as a machine learning algorithm utilizing the usage pattern of the user (node 420) and the aggregate data, the updated portion 402 has been updated to include different nodes and thereby services for subsequent exploration or interaction by the user (node 420).

For example, the updated portion 402 includes a different horizon or different services offered for exploration or preview such as nodes 426 (which may represent a cloud storage service) and 428 (which may represent a computer informational technology service). Additionally, updated portion 402 illustrates the potential rearrangement of nodes or services and the relationships between services. For example, updated portion 400 illustrates node 430, which represents a computer accessory ordering service, at a different location than updated portion 402. Updated portion 402 illustrates a rearranged location or hierarchy of node 430 and the association of node 430. For example, updated portion 402 illustrates node 430, and its related service, as being associated with the VIP service and its subsequent association with the IT service (node 428). Updated portion 402 also illustrates the rearrangement or re-association of services and nodes such as the appearance of node 426 that is not included in updated portion 400 for user 404. Updated portion 402 may include one or more nodes 432 that represent services offered by a service provider, one or more paths 434 that represent the associations and relationships between the services offered, and one or more indicators 436 that represent the status of related nodes. Thus, updated portions 400 and 402 illustrate the various user interfaces that can be generated by systems implementing embodiments described herein that include different explored paths (410 and 422) that result in different horizons or preview and locked nodes (416, 418, and 430 for updated portion 400 and 424, 426, 428 for updated portion 402) to inform and guide the user in exploring different services offered by a service provider. It should be noted that while nodes, such as nodes 408, 416, 430, etc., may represent a service offered by a service provider, the nodes may also represent an initial hierarchy node that may be expanded upon interaction by a user. For example, node 426 (the cloud storage service) may, upon appropriate interaction by the user, update and expand into one or more additional children nodes that fall under the umbrella of cloud storage service (such as media file upload, media file sharing, etc.). Thus, various organizational user interfaces may be generated and provided to a user as to not inundate or intimidate the user by presenting all available services. For example, a user may feel completely lost or confused if presented with a tree graph that includes 300 nodes. However, embodiments described herein may generate and expand user interfaces that include a smaller number of services that grows as the user explores or interacts with the user interface over time.

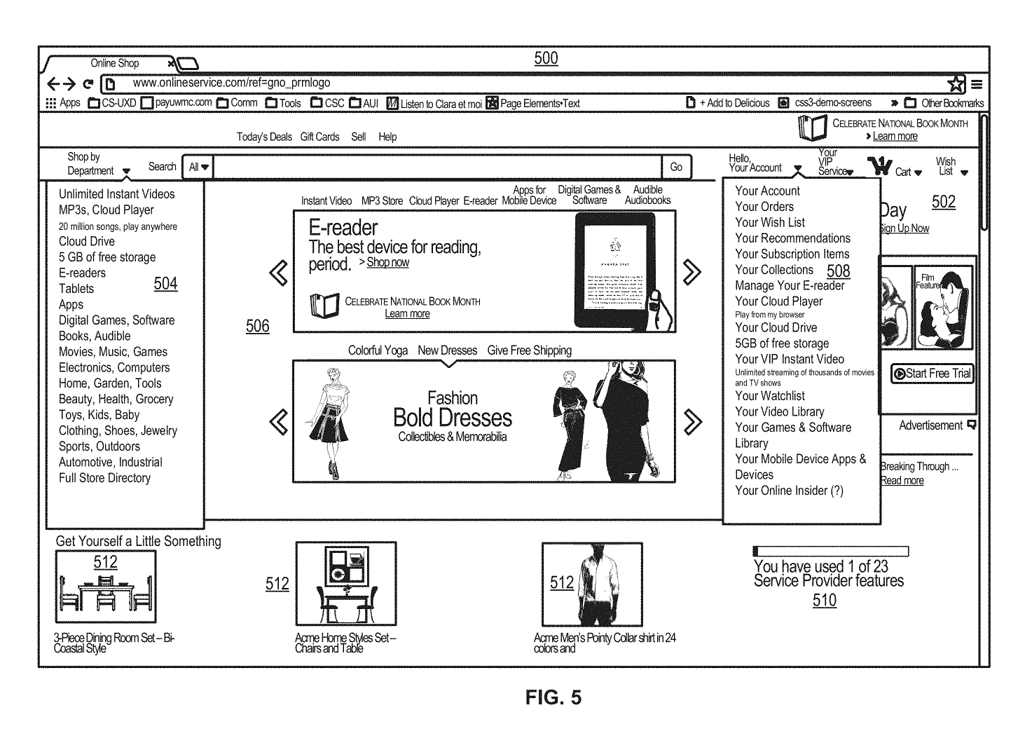

FIG. 5 illustrates an example service provider interface associated with services offered by a service provider, according to embodiments. FIG. 5 includes a web page browser 500 that presents a user interface 502 associated with an electronic marketplace that offers items for order and delivery. The user interface 502 may include item department designations 504, recommendations for particular items 506, and user account options 508. The user interface 502 also includes a feature/service status indicator 510 that illustrates a particular users progress through services offered by a service provider. As a user progresses or explores through their own particularized dynamic user interface, such as tree graph 106 of FIG. 1, the status indicator 510 will appropriately update to inform the user of their progress. Additionally, the status indicator 510 can be associated with multiple web pages or network documents presented by the service provider to aid the user in understanding their progress or in creating curiosity into under or un-utilized services offered by the service provider.

In embodiments, the status indicator 510 may direct or enable the user to view the service provider interface associated with services provided by a service provider as described above in FIGS. 1-4. In accordance with at least one embodiment, the recommendations for particular items 506 may be based on the services/features explored or interacted with by the user. For example, data can be captured from the dynamic user interface provided to a particular user indicating which services and in which order the services were interacted with by the particular user. A recommendation service associated with embodiments described herein can utilize the data to determine the content presented or provided in recommendations 506. In embodiments, advertisements, such as advertisements 512, may be generated and provided via the user interface 502 based on the usage pattern or user behavior associated with services/features provided by the service provider.

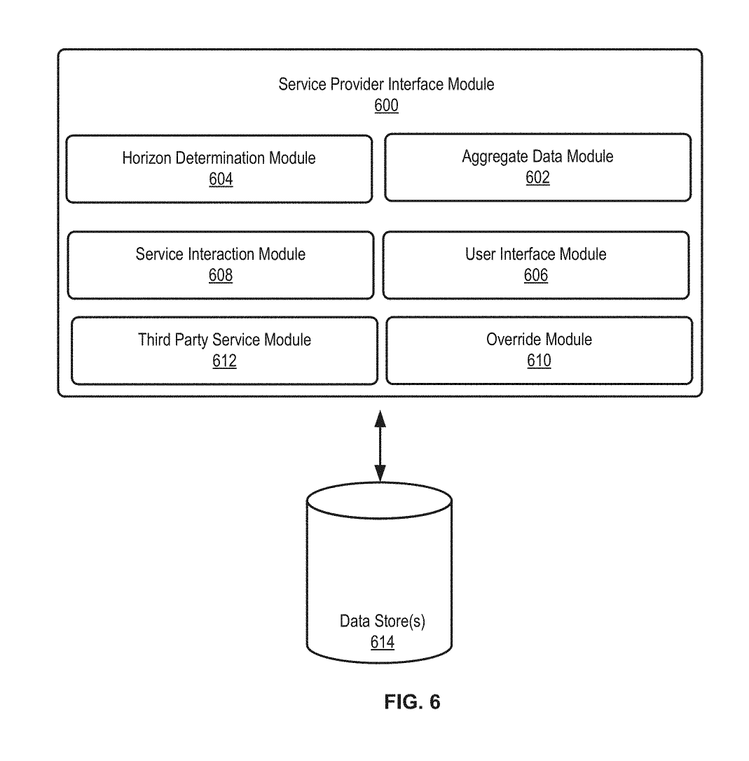

FIG. 6 illustrates an example service provider interface module, according to embodiments. In accordance with at least one embodiment, the service provider interface module 600 may include an aggregate data module 602, a horizon determination module 604, a user interface module 606, a service interaction module 608, an override module 610, and a third party service module 612 that may be in communication with one or more data stores 614. The modules included within and including the service provider interface module 600 may be software modules, hardware modules or a suitable combination thereof. If the modules are software modules, the modules can be embodied on a non-transitory computer readable medium and processed by a processor in any of the computer systems described herein. It should be noted that the described processes and architectures described below can be performed either in real-time or in an asynchronous mode prior to any user interaction. The modules may be configured in the manner suggested in FIG. 6 or may exist as separate modules.

In accordance with at least one embodiment the aggregate data module 602 may be configured to capture or obtain aggregate user data from a plurality of users interactions with services provided by a service provider. The aggregate data module 602 may maintain the aggregate user data in the data stores 614 and update the aggregate user data over time as new data is captured or obtained from the user interactions with services provided by the service provider. In embodiments, the aggregate user data may be utilized in generating an initial dynamic user interface that represents the relationships and associations between services offered by the service provider. The updated aggregate user data may be utilized by the service provider interface module 600 to update or change the initial dynamic user interface for subsequent users. The updated initial dynamic user interface may include different relationships or associations between services which may change the visual representation and thus the interaction or path taken by the user interacting with the dynamic user interface. In embodiments, the service provider interface module 600 may implement a supervised machine learning algorithm that utilizes the updated aggregate user data to change the initial user interface. The aggregate data module 602 may be configured to categorize users usage patterns into various segments based on their selections, interactions, or exploration of services included in the service provider interface described herein. The various segments may be utilized to identify portions of the aggregate data to be used by the machine learning algorithm in either identifying horizons, via horizon determination module 604, or in updating the initial dynamic user interface, via the service provider interface module 600. The various segments may be based on the user's path through the dynamic user interface, or other information available from the service provider such as recently ordered items, recently viewed items, subscribed to services, or any other suitable available information from a service provider that can be utilized to tie user information together into segments.

In embodiments, the service interaction module 608 may be configured to generate and provide information enabling the user to appropriately interact or explore a service included in the dynamic connection interface and be awarded with credit for exploring or interacting with the service. For example, as described in FIG. 2, the provided information may include text, graphics, sound, pre-recorded video, or streaming video instructing the user on how to interact with a service associated with a node that the user is interacting with via the dynamic connection interface. The service interaction module 608 may generate a default interaction based on prerequisites of associated services (must be a VIP member to take advantage of VIP shipping). The service interaction module 608 may be configured to receive input from a developer or administrator associated with the service provider that may specify the instructions or actions to be taken by a user with an associated service to properly explore/interact with said service. The service interaction module 608 may be configured to provide hyperlinks to the information or to enable the user to be directed to the associated service directly from the dynamic connection interface and/or the provided information itself.

In accordance with at least one embodiment, the third party service module 612 may be configured for receiving, requesting, and analyzing services/features and the relationships between the services/features provided by a third party and generating an initial dynamic user interface via the service provider interface module 600 for the third party. As described above, the service provider interface module 600 may use a machine learning algorithm, that in turn utilizes the third party service/feature and service/feature relationship information, to generate the initial dynamic user interface (such as an initial tree graph that represents the services and the relationships between the services provided by a third party). The third party service module 612 may receive usage patterns or user behavior of users associated with a third party service provider (in other words the interactions of the users with the services provided by the third party) to update the initial dynamic user interface or generate appropriate horizons via the horizon determination module 604. The user interface module 606 may, in conjunction with the service provider interface module 600 and horizon determination module 604, communicate the updates/changes to a dynamic user interface for a user. In embodiments, usage patterns or user behavior of users associated with both the service provider and the third party service providers may be analyzed and leveraged to update the initial dynamic user interface or generate appropriate horizons via the horizon determination module 604 for a user interface that is provided and presented to users of the service provider. In an embodiment, the third party service module 612 may be configured to analyze and determine services offered by a third party service provider, maintain shared users between the third party service provider and the service provider, and utilize the user behavior of the shared users on the third party service provider. This information may be used to generate and recommend services, for use in the horizon determination, based on similar services offered by both service providers. For example, if both services offer expedited shipping and the usage behavior indicates that a user utilizes the expedited shipping for the third party service provider but not for the service provider, the horizon determination module 604 may generate an appropriate horizon that includes the expedited shipping service offered by the service provider.

The user interface module 606 may be configured to graphically update the changes or updates to service placement and service relationships (such as node placement and path generation in a tree graph as in FIGS. 1-4) based on input from modules 600, 602, and 604. The user interface module 606 may also update or alter the dynamic user interface from one user interface representation to another representation based on the amount of interaction or exploration of a particular user and the amount of services offered by a particular service provider. For example, a particular service provider may offer 100 services/features. The presentation of the 100 services/features all at once may intimidate a user into abandoning the service provider. However, a portion of the services/features may be provided in such a way to hide or make in accessible certain portions of the features and various UI implementations may aid in hiding the sheer amount of services/features. For example, the user interface module 606 may determine, based on aggregate user data, that a series of web pages or a small site map representing only a portion of services offered by a user interface are appropriate. However, upon the user's exploration/interaction with the portion of services growing, a tree graph representing more services may be provided to the user. The order in which the various UI implementations are presented to the user may also be specified by an administrator or developer associated with the service provider. The user interface module 606 may be configured to update the status indicator described in FIGS. 1 and 5 above as the user interacts or explores more services offered by the service provider.

In accordance with at least one embodiment, the horizon determination module 604 may be configured to determine a portion of a user interface element to update based on information that includes an interaction by a user with a service provider and the aggregate user data obtained by the aggregate data module 602. The horizon determination module 604 may generate and provide instructions to update/change the user interface element, such as a tree graph illustrated in FIGS. 1-4, to make accessible features/services that were previously inaccessible to the user interacting with the user interface element. The determination of the portion of the user interface element by the horizon determination module 604 aids in incrementally revealing or making accessible portions of a user interface element which may aid a user in discovering various features provided by a service provider. The user may be presented with the updated user interface that includes features that were previously inaccessible and explore the services that are associated with the updated portion of the user interface element (such as by interacting with recently revealed nodes in a tree graph and following instructions to interact with the associated service). In embodiments, the horizon determination module 604 may determine the services/features to associate with the updated portion of the user interface based on the information that includes an interaction by a user with a service provider and the aggregate user data obtained by the aggregate data module 602. The horizon determination module 604 may select a subsidiary service associated with the service provider to associate with the updated portion of the user interface (or a node of a tree graph as illustrated in FIGS. 1-4).

In accordance with at least one embodiment, the horizon determination module 604 may determine the updated portion of the user interface element based on a machine learning algorithm that utilizes the information that includes an interaction by a user with a service provider and the aggregate user data obtained by the aggregate data module 602. In embodiments, the machine learning algorithm or the horizon determination module 604 may utilize other information obtained by the service provider or from the user themselves interacting with the service provider. For example, information obtained from a user device associated with the user may be obtained by the service provider or received from the user device. The information from the user device may include information about applications that are local to the user device or services utilized by the user of the user device including when particular services were accessed and in what order the services were interacted with by the user of the device. Information received from the service provider may include usage history of the user such as items ordered, purchased, or viewed, and services interacted with that are offered by the service provider. The horizon determination module 604 may also generate and provide for presentation a survey to users associated with the service provider that polls a plurality of users regarding the services offered by the service provider. The horizon determination module 604 may utilize the results of the surveys to determine the portion of the user interface element to update as described above. The horizon determination module 604 may pre-compute the updated portion or the horizon for the user interface element based on the information that includes an interaction by a user with a service provider and the aggregate user data obtained by the aggregate data module 602. In embodiments, the horizon determination module 604 may make event driven determinations of which portion of the user interface should be updated (associate services with user interface elements and provide for presentation the elements that were previously inaccessible) where the event includes information that includes an interaction by a user with a service provider. Thus, the horizon determination module 604 may consistently make dynamic changes/updates to the user interface in response to events driven by the user interacting with services offered by the service provider or by interacting with the dynamic user interface itself.

In accordance with at least one embodiment, the override module 610 may be configured to receive input from a developer or administrator associated with a service provider to generate and provide for presentation an initial dynamic user interface element, such as an initial tree graph as illustrated in FIG. 3. The override module 610 may receive input from the developer or administrator associated with the service provider to update, alter, or define the relationships between services offered by a service provider or the location of a particular service in which every type of dynamic user interface that is utilized by embodiments described herein. The override module 610 may also maintain attributes associated with each service that can be communicated to and utilized by the horizon determination module 604 in selecting which services to associate with the updated portions of the user interface. For example, particular attributes of a service may prohibit certain relationships as prerequisites may need to be fulfilled before one service can be associated with another service (a cloud storage service may require interaction with various streaming media services in order to be associated with one another). The horizon determination module 604 may utilize the attributes associated with each service to weigh the selection of a particular service to associate with the updated portion of the user interface and aid in selecting the service which may be most useful and appropriate for the particular user given their usage patterns of services offered by the service provider and aggregate user data that indicates the usage patterns of a plurality of users who have similar usage patterns.

In accordance with at least one embodiment, the dynamic user interface module 600 may generate and provide recommendations or advertisements for presentation to users associated with the service provider based on the usage patterns or user behavior of services provided by the service provider. For example, the dynamic user interface module 600 may obtain data for each user of a plurality of users that interacts with the dynamic user interface as described herein. The interactions, selections, or path through the dynamic user interface (such as the path of nodes selected in the tree graph of FIGS. 1-4) may be analyzed and leveraged to populate content for targeting the users in other web sites associated with the service provider. The same leveraged information may be provided to other services, such as third party services, for generating content that targets each user based on their usage patterns with services offered by the service provider.

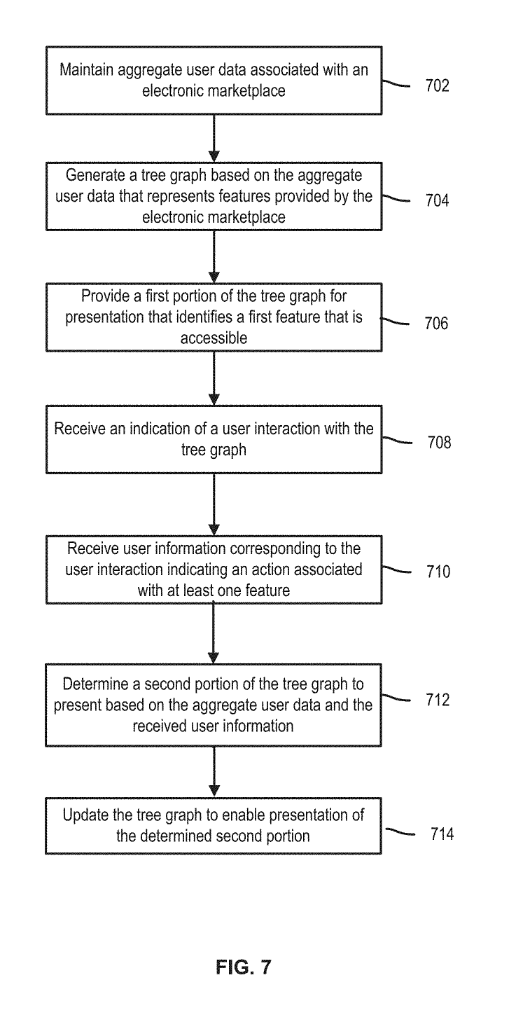

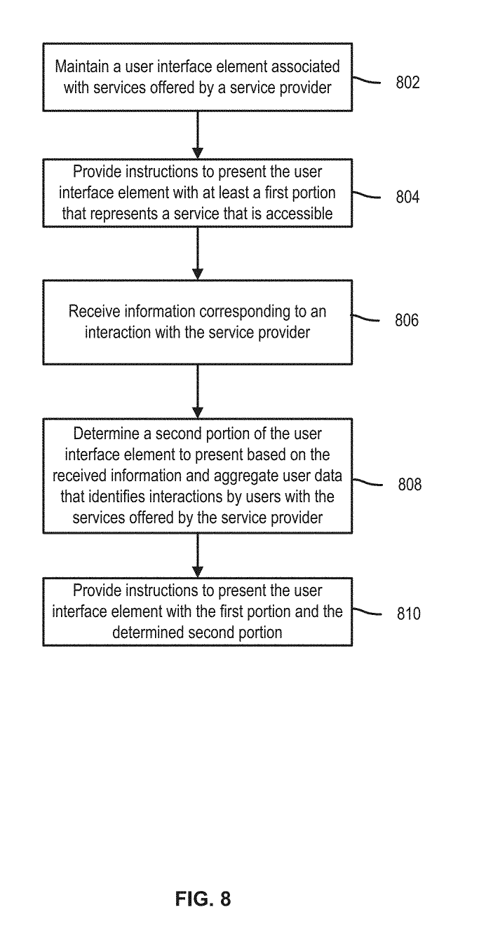

FIGS. 7 and 8 illustrate example flow diagrams for a service provider interface associated with services offered by a service provider, according to embodiments. These processes are illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer executable instructions include routines, programs, objects, components, data structures and the like that perform particular functions or implement particular data types. The order in which the operations are described is not intended to be construed as a limitation, and any number of the described operations can be combined in any order and/or in parallel to implement the processes.

Additionally, some, any, or all of the process (or any other processes described herein, or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. As noted below, the code may be stored on a computer-readable storage medium, for example, in the form of a computer program including a plurality of instructions executable by one or more processors. The computer-readable storage medium may be non-transitory.

In some examples, one or more service provider computers (e.g., utilizing at least one of a service provider interface module 600, an aggregate data module 602, and a horizon determination module 604 in communication with one or more data stores 612) shown in FIG. 6, may perform the processes 700 and 800 of FIGS. 7 and 8. In FIG. 7 the process 700 may include maintaining aggregate user data associated with an electronic marketplace at 702. In embodiments, the aggregate user data may identify interactions with one or more features provided by the electronic marketplace. The process 700 may include generating a tree graph based on the aggregate user data that represents features provided by the electronic marketplace at 704. The tree graph may include a plurality of nodes where each node represents a feature of one or more features provided by the electronic marketplace. The process 700 may include providing a first portion of the tree graph for presentation that identifies a first feature that is available at 706. For example, the first portion of the tree graph may only reveal a portion of features that are available to be interacted with by a user interacting with the tree graph so as not to inundate the user with too many features at once.

The process 700 may include receiving an indication of a user interaction with the tree graph at 708. In embodiments, the indication may include information that a user has clicked on or interacted with a particular node of the tree graph and has been presented with information that correlates to the feature represented by the node. The process 700 may include receiving user information corresponding to the user interaction indicating an action associated with at least one feature at 710. In an embodiment, the user information may indicate that a user has successfully subscribed to a service/feature offered by the electronic marketplace or uploaded a media file to a media server provided in accordance with the service/feature offered by the electronic marketplace. The process 700 may include determining a second portion of the tree graph to present based on the aggregate user data and the received user information at 712. In embodiments, the second portion of the tree graph may include features that were previously in an unrevealed state or were previously inaccessible to the user interacting with the tree graph. The process 700 may conclude at 714 by updating the tree graph to enable presentation of the determined section portion. As described herein, by updating the tree graph incrementally to include new horizons comprised of new features/services, the user may be guided to learn and interact with a number of features/services provided by a service provider such as an electronic marketplace.

In FIG. 8, the process 800 may include maintaining a user interface element associated with services offered by a service provider at 802. As described herein, the user interface element may include a tree graph an a cyclical or cyclical graph, a series of web pages, a site map, or any graph suitable for representing services/features offered by a service provider. The process 800 may include providing instructions to present the user interface element with at least a first portion that represents a service that is accessible at 804. The user interface element and the first portion may utilize various indicators to represents different states of the user interface element that are available or accessible to the user interacting with the user interface element. The process 800 may include receiving information corresponding to an interaction with the service provider at 806. The information corresponding to an interaction with the service provider may include information that indicates that a user has taken an action or caused an event that affects other services/features included in the user interface element by successfully completing one or more prerequisites directed by the service provider with reference to a particular feature/service.

The process 800 may include determining a second portion of the user interface element to present based on the received information and aggregate user data at 808. The aggregate user data may identify interactions by users with the services offered by the service provider. The process 800 may conclude at 810 by providing instructions to present the user interface element with the first portion and the determined second portion. The user interface element presenting both the first portion and the determined second portion would reveal or make accessible features that were previously inaccessible or hidden from the user. By revealing the portions of the user interface incrementally the service provider may guide or generate a path for the user to explore various features/services provided by the service provider without causing confusion or frustration to the user.

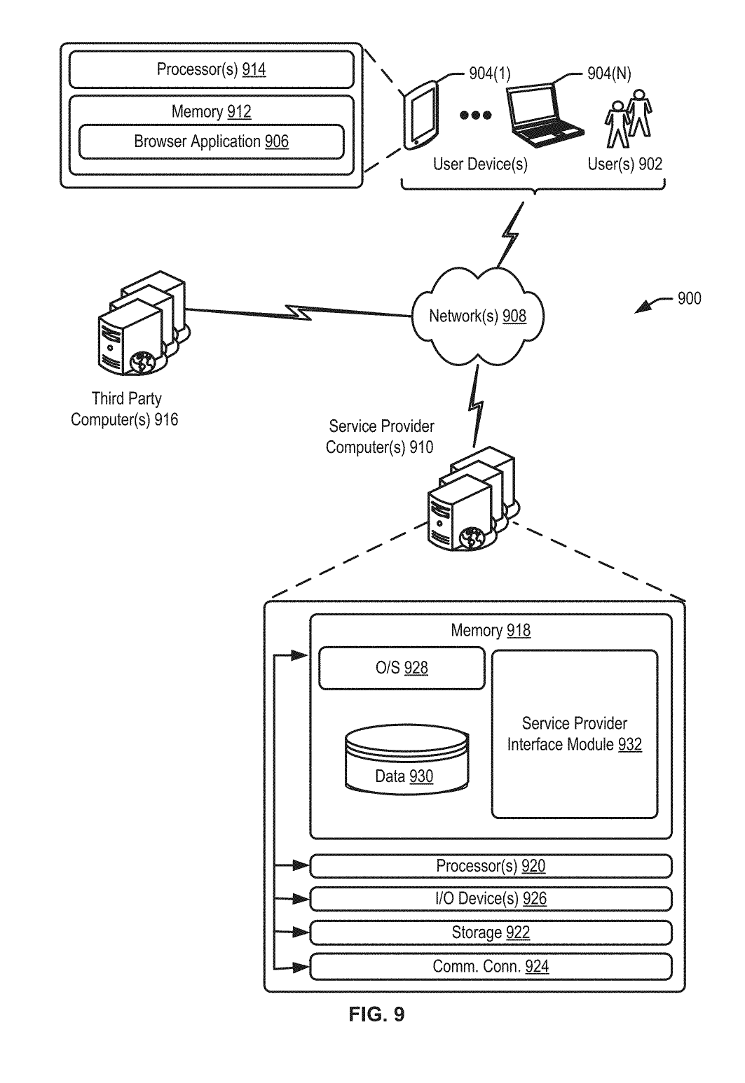

FIG. 9 illustrates an example computer architecture for implementing a service provider interface associated with services offered by a service provider, according to embodiments. In architecture 900, one or more users 902 (e.g., users) may utilize user computing devices 904(1)-(N) (collectively, user devices 904) to access a browser application 906 (e.g., a network document browser) or a user interface (UI) accessible through the browser application 906, via one or more networks 908 to access a service provider interface that represents services offered by a service provider as described herein. The “browser application” 906 can be any browser control or native application that can access and display a web page or other information. In some aspects, the browser application 906 may display an interactive UI for interacting with nodes of a tree graph or user interface elements that have been updated by the system implementing the embodiments as described herein.

The architecture 900 may also include, one or more service provider computers 910 that may, in some examples, provide computing resources such as, but not limited to, client entities, low latency data storage, durable data storage, data access, management, virtualization, hosted computing environment or “cloud-based” solutions, electronic content performance management, etc. The one or more service provider computers 910 may also be operable to provide site hosting, computer application development, and/or implementation platforms, combinations of the foregoing, or the like to the one or more users 902.

In one illustrative configuration, the user computing devices 904 may include at least one memory 912 and one or more processing units or processor(s) 914. The processor(s) 914 may be implemented as appropriate in hardware, computer-executable instructions, firmware, or combinations thereof. Computer-executable instruction or firmware implementations of the processor(s) 914 may include computer-executable or machine-executable instructions written in any suitable programming language to perform the various functions described herein. The user devices 904 may also include geo-location devices (e.g., a global positioning system (GPS) device or the like) for providing and/or recording geographic location information associated with the user devices 904. The memory 912 may store program instructions that are loadable and executable on the processor(s) 914, as well as data generated during the execution of these programs. Depending on the configuration and type of user device 904, the memory 912 may be volatile (such as random access memory (RAM)) and/or non-volatile (such as read-only memory (ROM), flash memory, etc.). The user device 904 may also include additional removable storage and/or non-removable storage including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 912 may include multiple different types of memory, such as static random access memory (SRAM), dynamic random access memory (DRAM), or ROM.

Turning to the components of the memory 912 in more detail, the memory 912 may include an operating system and one or more application programs or services for implementing the features disclosed herein including presenting a service provider interface that represents relationships between services offered by a service provider that has been generated by the service provider computers 910 for presentation to the user 902 via the browser application 906, dedicated applications (e.g., smart phone applications, tablet applications, etc.), or through capabilities inherit to a device (e.g., user interfaces or touch input interfaces). Additionally, the memory 912 may store access credentials and/or other user information such as, but not limited to, user IDs, passwords, and/or other user information. In some examples, the user information may include information for authenticating an account such as, but not limited to, a device ID, a cookie, an IP address, a location, or the like. In addition, the user information may include a user 902 provided response to a security question or a geographic location obtained by the user device 904.

In some examples, the networks 908 may include any one or a combination of many different types of networks, such as cable networks, the Internet, wireless networks, cellular networks and other private and/or public networks. While the illustrated example represents the users 902 communicating with the service provider computers 910 over the networks 908, the described techniques may equally apply in instances where the users 902 interact with the one or more service provider computers 910 via the one or more user devices 904 over a landline phone, via a kiosk, or in any other manner. It is also noted that the described techniques may apply in other client/server arrangements (e.g., set-top boxes, etc.), as well as in non-client/server arrangements (e.g., locally stored applications, peer-to-peer arrangements, etc.).

As described briefly above, the browser application 906 may allow the users 902 to view and interact with a service provider interface representative of services offered by a service provider that has been provided by the service provider computers 910. The browser application 906 may be capable of handling requests from many users 902 and serving, in response, various user interfaces that can be rendered at the user devices 904 such as, but not limited to, a network site or web page. The browser application 906 can interact with any type of network site that supports user interaction, including social networking sites, electronic retailers, informational sites, blog sites, search engine sites, news and entertainment sites, electronic marketplaces, and so forth. The described techniques can similarly be implemented outside of the browser application 906, such as with other applications running on the user device 904. In some examples, the one or more service provider computers 910 may communicate with one or more third party computers 916 to provide a dynamic user interface feature to third parties that provide the requisite data as described herein.

The one or more service provider computers 910 may be any type of computing device such as, but not limited to, a mobile phone, a smart phone, a personal digital assistant (PDA), a laptop computer, a desktop computer, a server computer, a thin-client device, a tablet PC, etc. Additionally, it should be noted that in some embodiments, the one or more service provider computers 910 may be executed by one or more virtual machines implemented in a hosted computing environment. The hosted computing environment may include one or more rapidly provisioned and released computing resources, which computing resources may include computing, networking, and/or storage devices. A hosted computing environment may also be referred to as a cloud computing environment or distributed computing environment. In some examples, the one or more service provider computers 910 may be in communication with the user device 904 via the networks 908, or via other network connections. The one or more service provider computers 910 may include one or more servers, perhaps arranged in a cluster or as individual servers not associated with one another.

In one illustrative configuration, the one or more service provider computers 910 may include at least one memory 918 and one or more processing units or processors(s) 920. The processor(s) 920 may be implemented as appropriate in hardware, computer-executable instructions, firmware, or combinations thereof. Computer-executable instruction or firmware implementations of the processor(s) 920 may include computer-executable or machine-executable instructions written in any suitable programming language to perform the various functions described when executed by a hardware computing device, such as a processor. The memory 918 may store program instructions that are loadable and executable on the processor(s) 920, as well as data generated during the execution of these programs. Depending on the configuration and type of the one or more service provider computers 910, the memory 918 may be volatile (such as RAM) and/or non-volatile (such as ROM, flash memory, etc.). The one or more service provider computers 910 or servers may also include additional storage 922, which may include removable storage and/or non-removable storage. The additional storage 922 may include, but is not limited to, magnetic storage, optical disks and/or tape storage. The disk drives and their associated computer-readable media may provide non-volatile storage of computer-readable instructions, data structures, program modules, and other data for the computing devices. In some implementations, the memory 918 may include multiple different types of memory, such as SRAM, DRAM, or ROM.

The memory 918, the additional storage 922, both removable and non-removable, are all examples of non-transitory computer-readable storage media. For example, computer-readable storage media may include volatile or non-volatile, removable or non-removable media implemented in any method or technology for storage of information such as computer-readable instructions, data structures, program modules, or other data. The memory 918 and the additional storage 922 are all examples of non-transitory computer storage media. Additional types of non-transitory computer storage media that may be present in the one or more service provider computers 910 may include, but are not limited to, PRAM, SRAM, DRAM, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by the one or more service provider computers 910. Combinations of any of the above should also be included within the scope of non-transitory computer-readable media.

The one or more service provider computers 910 may also contain communication connection interface(s) 924 that allow the one or more service provider computers 910 to communicate with a data store, another computing device or server, user terminals and/or other devices on the networks 908. The one or more service provider computers 910 may also include I/O device(s) 926, such as a keyboard, a mouse, a pen, a voice input device, a touch input device, a display, speakers, a printer, etc.

Turning to the contents of the memory 918 in more detail and as was described above in further detail in FIG. 6, the memory 918 may include an operating system 928, one or more data stores 930, and/or one or more application programs or services for implementing the features disclosed herein including a service provider interface module 932 (which may be an example of dynamic user interface module 600). In accordance with at least one embodiment, the service provider interface module 932 may be configured to at least maintain aggregate data indicating interactions by a plurality of users with services offered by a service provider, generate and provide a user interface that represents the services offered by the service provider, receive information including an action or event by a particular user with a service, determine a portion of the user interface to update based on the aggregate data and the received information, and update the user interface to include the portion that includes previously inaccessible or unrevealed services that are related to services that the user has successfully interacted with.

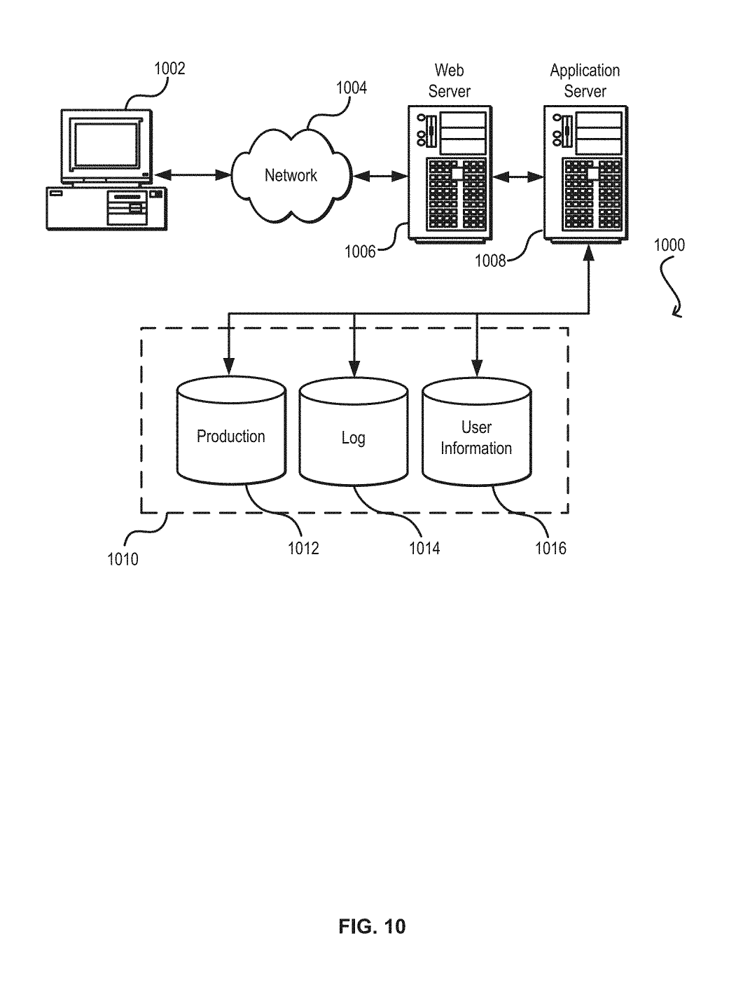

FIG. 10 illustrates aspects of an example environment 1000 for implementing aspects in accordance with various embodiments. As will be appreciated, although a Web-based environment is used for purposes of explanation, different environments may be used, as appropriate, to implement various embodiments. The environment includes an electronic client device 1002, which can include any appropriate device operable to send and receive requests, messages or information over an appropriate network 1004 and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections and combinations thereof. In this example, the network includes the Internet, as the environment includes a Web server 1006 for receiving requests and serving content in response thereto, although for other networks an alternative device serving a similar purpose could be used as would be apparent to one of ordinary skill in the art.

The illustrative environment includes at least one application server 1008 and a data store 1010. It should be understood that there can be several application servers, layers, or other elements, processes or components, which may be chained or otherwise configured, which can interact to perform tasks such as obtaining data from an appropriate data store. As used herein the term “data store” refers to any device or combination of devices capable of storing, accessing and retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device, handling a majority of the data access and business logic for an application. The application server provides access control services in cooperation with the data store and is able to generate content such as text, graphics, audio and/or video to be transferred to the user, which may be served to the user by the Web server in the form of HyperText Markup Language (“HTML”), Extensible Markup Language (“XML”) or another appropriate structured language in this example. The handling of all requests and responses, as well as the delivery of content between the client device 1002 and the application server 1008, can be handled by the Web server. It should be understood that the Web and application servers are not required and are merely example components, as structured code discussed herein can be executed on any appropriate device or host machine as discussed elsewhere herein.

The data store 1010 can include several separate data tables, databases or other data storage mechanisms and media for storing data relating to a particular aspect. For example, the data store illustrated includes mechanisms for storing production data 1012 and user information 1016, which can be used to serve content for the production side. The data store also is shown to include a mechanism for storing log data 1014, which can be used for reporting, analysis or other such purposes. It should be understood that there can be many other aspects that may need to be stored in the data store, such as for page image information and to access right information, which can be stored in any of the above listed mechanisms as appropriate or in additional mechanisms in the data store 1010. The data store 1010 is operable, through logic associated therewith, to receive instructions from the application server 1008 and obtain, update or otherwise process data in response thereto. In one example, a user might submit a search request for a certain type of item. In this case, the data store might access the user information to verify the identity of the user and can access the catalog detail information to obtain information about items of that type. The information then can be returned to the user, such as in a results listing on a Web page that the user is able to view via a browser on the user device 1002. Information for a particular item of interest can be viewed in a dedicated page or window of the browser.

Each server typically will include an operating system that provides executable program instructions for the general administration and operation of that server and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 10. Thus, the depiction of the system 1000 in FIG. 10 should be taken as being illustrative in nature and not limiting to the scope of the disclosure.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”) and AppleTalk. The network can be, for example, a local area network, a wide-area network, a virtual private network, the Internet, an intranet, an extranet, a public switched telephone network, an infrared network, a wireless network and any combination thereof.

In embodiments utilizing a Web server, the Web server can run any of a variety of server or mid-tier applications, including Hypertext Transfer Protocol (“HTTP”) servers, FTP servers, Common Gateway Interface (“CGI”) servers, data servers, Java servers and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase® and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen or keypad) and at least one output device (e.g., a display device, printer or speaker). Such a system may also include one or more storage devices, such as disk drives, optical storage devices and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.) and working memory as described above. The computer-readable storage media reader can be connected with, or configured to receive, a computer-readable storage medium, representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications and patents, cited herein are hereby incorporated by reference to the same extent as if each reference were individually and specifically indicated to be incorporated by reference and were set forth in its entirety herein.

1. A computer-implemented method, comprising:
maintaining aggregate user data associated with an electronic marketplace, the aggregate user data identifying interactions with one or more features provided by the electronic marketplace;
generating a user interface based at least in part on the aggregate user data, the user interface comprising a plurality of nodes that represent an interrelationship between the one or more features, the interrelationship being specified by an entity associated with the electronic marketplace, a node of the plurality of nodes representing a feature of the one or more features provided by the electronic marketplace;
providing at least a first portion of the user interface for presentation, the first portion identifying a first feature of the one or more features that is accessible and obscuring other features of the one or more features provided by the electronic marketplace;
receiving an indication of a user interaction with a particular node of the user interface;
receiving user information corresponding to the user interaction, the user information indicating an action associated with at least one of the one or more features and representing a usage pattern for the one or more features;
determining a second portion of the user interface to reveal for presentation by moving one or more nodes of the plurality of nodes within the user interface from an initial configuration to a modified configuration based at least in part on the maintained aggregate user data and the received user information; and
updating the user interface to enable presentation of the determined second portion, the determined second portion representing a preview of the other features that can be accessed by a user interacting with corresponding features provided by the electronic marketplace.

2. The computer-implemented method of claim 1, wherein enabling presentation of the determined second portion includes identifying a second feature of the one or more features that was previously inaccessible.

3. The computer-implemented method of claim 1, further comprising identifying a segment of the maintained aggregate user data based at least in part on the received user information.

4. The computer-implemented method of claim 3, wherein determining the second portion of the user interface to present is further based at least in part on the identified segment of the maintained aggregate user data and the received user information.

5. The computer-implemented method of claim 1, wherein determining the second portion of the user interface to present is based at least in part on a machine learning algorithm that utilizes the maintained aggregate user data and the received user information.

6. A non-transitory computer-readable storage medium storing computer-executable instructions that, when executed by a computer system, configures the computer system to perform operations comprising:
maintaining a user interface object comprised of a plurality of user interface elements that represent an interrelationship between services offered by a service provider, a user interface element of the plurality of user interface elements representing a service of the services;
providing instructions to present the user interface object with at least a first portion revealed that obscures other portions of the user interface object, the first portion corresponding to the service of the services that is accessible;
receiving information corresponding to an interaction with the service provider;
determining a second portion of the user interface object to present by moving one or more user interface elements of the plurality of user interface elements from an initial configuration to a modified configuration based at least in part on the received information and aggregate user data that identifies interactions by a plurality of users with the services offered by the service provider; and
updating the user interface object to present the determined second portion, the determined second portion representing a preview of other services of the services that can be accessed by a user interacting with corresponding services offered by the service provider.

7. The non-transitory computer-readable storage medium of claim 6, wherein the operations further comprise obtaining a series of interactions by a user with the service provider, the aggregate user data updated based on the series of interactions by the user with the service provider.

8. The non-transitory computer-readable storage medium of claim 7, wherein determining the second portion of the user interface object to present is further based at least in part on the series of interactions of the user and the aggregate user data.

9. The non-transitory computer-readable storage medium of claim 6, wherein the operations further comprise selecting a type of the plurality of user interface elements to associate with the services offered by the service provider based at least in part on a number of the services offered by the service provider.

10. The non-transitory computer-readable storage medium of claim 9, wherein the operations further comprise changing the type of the user interface element to associate with the services offered by the service provider based at least in part on the received information corresponding to the interaction with the service provider and the number of the services offered by the service provider.

11. The non-transitory computer-readable storage medium of claim 6, wherein the operations further comprise generating an advertisement for presentation to a user of the service provider based at least in part on the received information corresponding to the interaction with the service provider and the determined second portion of the user interface object, the advertisement including content that corresponds to the service provider.

12. The non-transitory computer-readable storage medium of claim 6, wherein the operations further comprise obtaining usage patterns of a user of the services offered by the service provider from an operating system of a user device associated with the user.

13. The non-transitory computer-readable storage medium of claim 12, wherein determining the second portion of the user interface object to present is further based at least in part on the obtained usage patterns of the user.

14. A computer system, comprising:
a processor; and
memory in communication with the processor, the memory including computer-executable instructions that, when executed by the processor, cause the computer system to at least:
maintain a user interface comprising one or more nodes that represent an interrelationship between services offered by a service provider, the interrelationship being specified by an entity associated with the service provider, a node of the one or more nodes representing a service of the services offered by the service provider;
present the user interface by revealing a first node of the one or more nodes that is accessible and obscuring other services of the services offered by the service provider;
receive information that indicates an interaction with a particular service of the services offered by the service provider;
identify a segment of user information that indicates a series of interactions by a plurality of users with the particular service based at least in part on the information;
obtain aggregate data based at least in part on the identified segment of user information, the aggregate data indicating interactions by the plurality of users with the services offered by the service provider;
determine to associate the particular service with a second node of the one or more nodes based at least in part on the received information and the obtained aggregate data, the particular service associated with the second node being previously inaccessible via the user interface; and
update the user interface to present the second node.

15. The computer system of claim 14, wherein the computer-executable instructions, when executed by the processor, further cause the computer system to at least update relationships between the one or more nodes of the user interface based at least in part on updated aggregate data that is obtained periodically from the service provider, wherein updating the relationships between the one or more nodes of the user interface includes updating the relationships for the one or more nodes that are previously inaccessible via the user interface.

16. The computer system of claim 15, wherein updating the relationship between the one or more nodes of the user interface is further based at least in part on input from an administrator associated with the service provider.

17. The computer system of claim 15, wherein the relationships between the one or more nodes of the user interface are represented by paths between the one or more nodes of the user interface, the paths and location of the one or more nodes of the user interface are determined based at least in part on attributes associated with each service of the services offered by the service provider.

18. The computer system of claim 14, wherein the computer-executable instructions, when executed by the processor, further cause the computer system to at least:
receive a request, from a third party service provider, the request including second aggregate data that indicates interactions by a second plurality of users with second services offered by the third party service provider and relationship information specifying relationships between the second services offered by the third party;
generate a user interface element associated with the second services offered by the third party service provider based at least in part on the second aggregate data and the relationship information; and
provide instructions to present the user interface element with at least a first portion that represents a particular service of the second services that is accessible to the second plurality of users.

19. The computer system of claim 14, wherein a particular node of the one or more nodes, when made accessible, expands into a plurality of nodes that each represent related services with respect to a service associated with the particular node.

20. The computer system of claim 14, wherein the computer-executable instructions, when executed by the processor, further cause the computer system to at least:
generate instructions that indicate how to interact with the particular service of the services that is associated with the second node of the user interface; and
provide the instructions to a user interacting with the user interface.
